(19) United States
(12) Patent Application Publication
(10) Pub. No.: US 2012/0192292 A1
(43) Pub. Date: Jul. 26, 2012

(54) CATEGORIZED CONTENT SHARING, IDENTICAL CONTENT MAINTANANCE AND USER PROTECTION IN A PEER-TO-PEER NETWORK

(75) Inventors: Meir Gershon, Binyamina (IL); Eli Rozenfeld, Moshav Ben Shemen (IL)

(73) Assignee: SEATECH LTD, Moshav Ben Shemen (IL)

(21) Appl. No.: 13/355,549

(22) Filed: Jan. 22, 2012

Related U.S. Application Data
(60) Provisional application No. 61/436,327, filed on Jan. 26, 2011.

(51) Int. Cl. G06F 21/00; G06F 15/16

(52) U.S. Cl. 726/30; 709/204

(57) ABSTRACT

Methods and apparatus for sharing content between devices over a peer-to-peer (P2P) network without servers. The content is distributed to all the devices connected to the network. The distributed content may be identical and/or categorized. The content may be marked with a trust rating, and a user is enabled to both report and delete inappropriate/defective content and also report trusted content. A user may also be protected from using inappropriate/defective/non-trusted content and may prevent re-sharing of such content by other users.

### CROSS REFERENCE TO RELATED APPLICATIONS

This application is related to and hereby claims the priority benefit of U.S. Provisional Patent Application No. 61/436,327 having the same title and filed Jan. 26, 2011.

### FIELD

Embodiments disclosed herein relate in general to peer-to-peer (P2P) content sharing and in particular to identical and/or categorized content sharing including sharing Web links, while dealing with defective/inappropriate/non-trusted content.

### BACKGROUND

Content sharing among different users connected through a communication link is known. Content may be communicated utilizing telephone lines, cable networks, powerline networks, Internet, wireless connectivity, wired connections, other communication types or combinations thereof. Content sharing systems allow users to share content but have some outstanding disadvantages regarding the content quality and the sharing process. One disadvantage is that the shared content is not categorized. As used herein, “categorized content” is content which is located in a category and sub-category. A “category” may or may not include a sub-category which includes content. The category and sub-category names represent the content type. For example, content of “cars for sale” may be in a “for sale” category under a “cars” sub-category, while “furniture for sale” may be in a “for sale” category under a “furniture” sub-category.

Searching for the right content in these systems requires a user to perform specific and complex searches through uncategorized lists of results sorted by the number of downloads and not by the amount of time the content was in use or reported as trusted by users (“non-trusted content”). In addition, each list may include duplicate results rendering the search even more difficult. After each search, the user must pull (download) the content in order to use it. The content pull duration is very long, because the content is usually divided among only a few system users, such that each user may have only a small part of the content. These users must be connected to the network to enable other users to pull the content from them. In addition, the search result list sometimes includes a result which seems to be available but is actually unavailable, because some parts of the requested content are held by retired users who will never connect to the system again.

The common content sharing systems include lots of inappropriate/defective content, because they allow users to share content with no restrictions. They also include content dedicated to specific groups and do not protect other groups from this content.

### DEFINITIONS

In this description, a “regular device” (or simply “device”) refers to a device that includes at least a processor such as a central processing unit (CPU), a memory and a communications interface. Examples of such devices include, but are not limited to, a personal computer (PC), a mini PC, a Home Theater PC (HTPC) and a set-top box.

A “user” is a person who uses a device, for example a person who activates content in a device.

A “sharing user” (“originator”) is a user who loads content to his/her device and shares it with all other devices.

A “P_device” is a device as defined above which also assists the distribution process and updates a non-updated device (i.e. a new device).

“Content” refers to data that users would like to share, including links, files, programs, movies, music, etc.

“Inappropriate content” refers to content which may hurt viewer feelings, for example having violent or sexual content.

“Defective content” refers to content which does not work properly, for example a stuck application or a broken link.

“Local content” refers to content loaded by a user into a local device, i.e. a device the user can access physically without communication over a network.

“Remote content” refers to content received by a device over the network.

“Trusted content” refers to content which has a trust rating above a predefined value. The trust rating of shared content is composed from (a) the number of times shared content was activated (viewed/used) for more than a predefined time period, and (b) the number of times the shared content was reported as trusted by users.

“Authorized content” refers to content which maintains content policy.

“Content policy” refers to copyright protection, content amount limitation, re-sharing of inappropriate/defective content prevention, re-sharing of existing content prevention and category matching.

“User defense” refers to a mechanism which protects a user from inappropriate/defective/non-trusted content.

A “user grade” of a user may include (a) the trust rating of the content which the user shared and (b) the number of times that shared content of a sharing user is reported by other users as inappropriate/defective.

### SUMMARY

Embodiments disclosed herein disclose methods and systems for sharing content between devices over a communication network such as the Internet, using peer-to-peer (P2P) topology without servers. In certain embodiments, a method disclosed herein maintains identical content in all devices using an automatic distribution technique, so users do not need to search and pull content manually. In certain embodiments, the content is categorized based on its substance. In certain embodiments, the content in each category is marked with a “trust” rating, and a user is enabled to delete inappropriate/defective content. The trust rating is exemplarily calculated as the number of times all users activated the content +5 X, where X is the number of users who report the content as trusted. The originator is not taken into account. A predefined threshold value which determine if the content is trusted or not may be for example 5-25% of the total devices. Content with a trust rating above the predefined value is considered “trusted content”.

In certain embodiments, a method disclosed herein protects the user by setting a password for content which is not trusted and for content dedicated to specific groups so other groups will not be able to access it.

In some embodiments, re-sharing of content that was deleted due to inappropriate/defective reports is prevented. In certain embodiments, a user is enabled to create inappropriate and/or defective content reports which cause a sharing user to count the inappropriate and/or defective content reports and to issue a deletion request to all devices when the inappropriate/defective content counter reaches a predefined threshold.

A user who wishes to share new content with other users organizes the content in categories and sub-categories prior to “locally” uploading the content to his/her respective device. While uploading the new content, the device checks if the user is allowed to share content, if there is enough space in the requested category for new content, and if the content is as defined in content policy rules. Such rules may include copyright protection, content amount limitation, re-sharing of inappropriate/defective content prevention, re-sharing of existing content prevention and category matching. In case the content is not as defined in the content policy, it may not be shared or it may be shared in the right category. That is, if a user tries to categorize content in the wrong category, the device may automatically insert it in the right category. For example, content for adults may automatically be categorized in the adult category even if the user tries to categorize it in other category. The adult category may be protected by (exemplarily) a password.

At the end of the local uploading process, the device spreads the new content to other devices. In some embodiments, in case the device does not update (sends the new content to) successfully at least a predefined number of P_devices, it may issue a deletion request to the devices which got the update and may try to update all devices later so all devices will include identical content. A P_device which received a content update from another device may spread the update to other devices.

When the device “starts”, it divides the content according to the trust rating, so content which is not trusted will, exemplarily, require a password for activation (use or viewing). In an embodiment, the content will be sorted in each category according to the trust rating and user grade, or according to its arrival time, depending on the user selection. The device GUI (graphical user interface) may display the following information for each content item: item description, nickname and grade of the originating user, content upload time and item trust value. In an embodiment, the user will be able to activate the content and report it as inappropriate and/or defective or trusted (if necessary). When the user chooses to activate content, the device will measure the time the content is being used and, if this time is longer than the predefined period, will report this content as trustworthy.

Every pre-defined period of time, the device may issue a statistics report which includes the list of content reported as trustworthy and may spread (send) the report to other devices. A device which received a statistics report from other devices may update its trust rating accordingly, and if it is a P_device, it may send the statistics report to other devices.

A method disclosed herein allows a user to create inappropriate and/or defective or trusted content reports. In case of an inappropriate and/or defective report, the device may send the report directly to the originating device. In case of a trusted report, the device may mark the content as trustworthy in the database (this report may be spread to other devices by the statistics update process). A device which received an inappropriate and/or defective content report from other devices may count the report. In case the reports counter reached a predefined threshold, the device may reduce the user grade which may limit his sharing abilities and issue a deletion request along with user grade update to all devices.

### BRIEF DESCRIPTION OF THE DRAWINGS

Aspects, embodiments and features disclosed herein will become apparent from the following detailed description disclosed herein when considered in conjunction with the accompanying drawings. In the drawings:

FIG. 1 illustrates schematically an embodiment of a system disclosed herein in which devices are connected in a P2P topology through a communication network;

FIG. 2a illustrates schematically in a block diagram the structure of a device in accordance with an embodiment disclosed herein;

FIG. 2b illustrates schematically modules in application component in FIG. 2a;

FIG. 3 illustrates in a flow chart the main steps of an embodiment of a method disclosed herein in which categorized and trusted content is shared among a plurality of devices connected in the system of FIG. 1;

FIG. 4 is a flowchart illustrating steps performed by a network connection module in the application component of FIG. 2b, in accordance with an embodiment disclosed herein;

FIG. 5 is a flowchart illustrating steps performed by a distribution module in the application component of FIG. 2b, in accordance with an embodiment disclosed herein;

FIG. 6 is a flowchart illustrating steps performed by a message receive module in the application component of FIG. 2b, in accordance with an embodiment disclosed herein;

FIG. 7 is a flowchart illustrating steps performed by a content editing module in the application component of FIG. 2b, in accordance with an embodiment disclosed herein;

FIG. 8 is a flowchart illustrating steps performed by a local content loading module in the application component of FIG. 2b, in accordance with an embodiment disclosed herein;

FIG. 9 is a flowchart illustrating steps performed by a user defense module in the application component of FIG. 2b, in accordance with an embodiment disclosed herein;

FIG. 10 is a flowchart illustrating steps performed by a remote content loading module in the system of FIG. 2b, in accordance with an embodiment disclosed herein;

FIG. 11 is a flowchart illustrating steps performed by a user activating module in the application component of FIG. 2b, in accordance with an embodiment disclosed herein;

FIG. 12 is a flowchart illustrating steps performed by a statistics module in the application component of FIG. 2b, in accordance with an embodiment disclosed herein.

### DETAILED DESCRIPTION

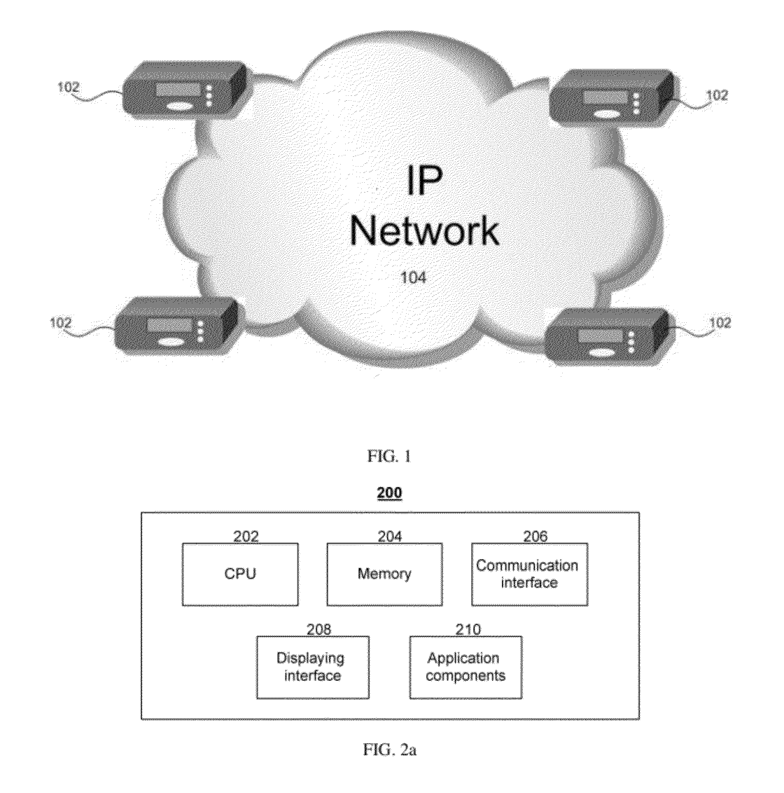

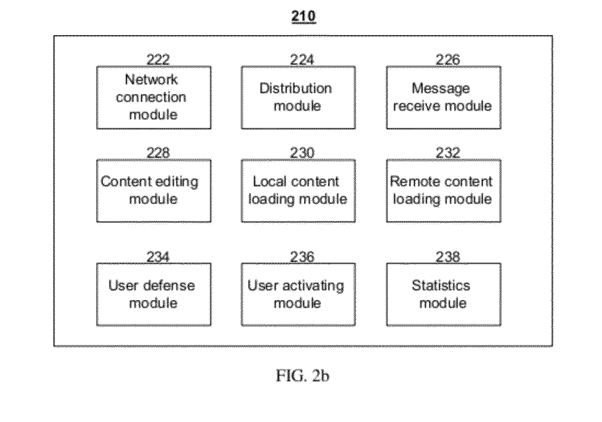

FIG. 1 illustrates schematically an embodiment of a system disclosed herein, in which a plurality of devices 102 are connected to each other in a P2P topology through a communication networks such as an Internet network 104. In some embodiments, a device 102 may exemplarily be a set-top box. In other embodiments, a device 102 may be a personal computer. In yet other embodiments, a device 102 may be any electronic device having modules and functionalities as shown in FIGS. 2a and 2b, i.e. functionalities which allow it to perform categorized content distribution and sharing and provide user defense.

FIG. 2a illustrates schematically in a block diagram the structure of a device 200 in accordance with an embodiment disclosed herein. In general, device 200 includes a processor such as a central processing unit (CPU) 202, a memory 204, a communication interface 206, a display interface 208 and an application component 210. The operation and functionalities of components 202-208 are as known in the art of devices such as PCs, set-top devices, mini PCs and HTPCs (Home Theater PCs). Application component 210 has special functionalities which enable the performance of the method embodiments disclosed herein, and is described in more detail with reference to FIG. 2b.

Exemplarily, as shown schematically in FIG. 2b, each application component 210 includes: a network connection module 222 for connecting to the network; a distribution module 224 for distributing content to other devices over the P2P network; a message receive module 226 for receiving shared content and messages from other devices over the P2P network; a content editing module 228 for editing the shared content before loading it to the device; a local content loading module 230 for loading the content to a local device (e.g. a device located on the premises of the user); a remote content loading module 232 for loading the content arriving from the network (other users); a user defense module 234 for protecting a user from inappropriate and/or defective and/or non-trusted content; a user activating module 236 for displaying the content to a user and for allowing the user to use/activate the content; and a statistics module 238 for spreading a trust value for each content item.

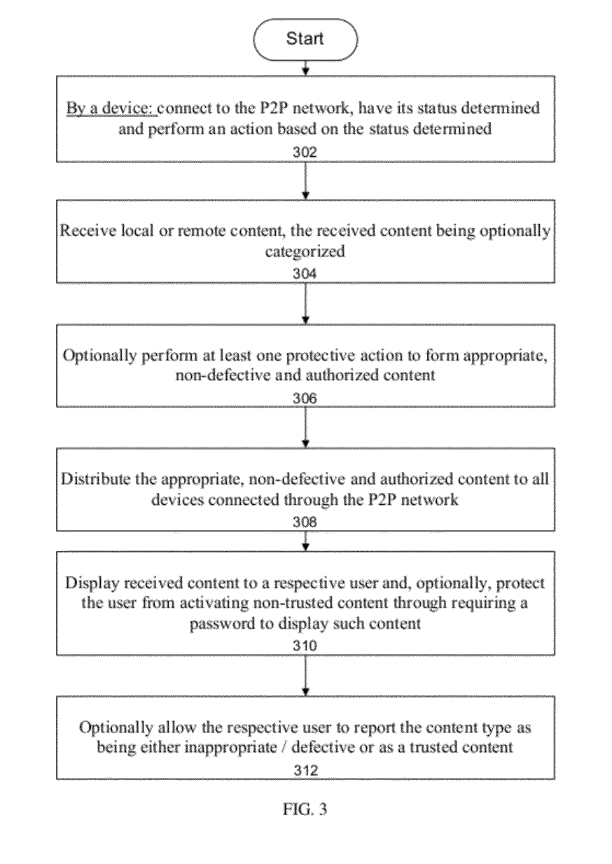

FIG. 3 illustrates in a flow chart the main steps of an embodiment of a method disclosed herein in which content is shared among a plurality of devices as shown in FIG. 1, wherein each device is as described above with reference to FIGS. 2a and 2b. In step 302, a particular device (referred to hereinafter simply as “the device”) connects to the P2P network, has its status determined and performs an action based on the status determined. Each device contacts a first “existing” (i.e. active, connected to the network) P_device and asks for the updated devices list. Assuming the status check indicates that the device is new or is a P_device which had its IP address changed, the device also asks the first existing P_device or another existing P_device for updated content and updates all other devices about its new IP address. In case the device is a regular device which was disconnected from the network for a long period of time, or is a P_device which did not have its IP address changed, the device asks another existing P_device for the updated content without updating the other devices about its IP address. In case the device is a regular device and its IP address was changed, the device updates all other devices about its new IP address without asking for the updated content. These actions are summarized in the following Table.

| | | | | Regular | Regular |
|---|---|---|---|---|---|
| | | P_device | | device | device |
| | | which had | | which | which had |
| | | its IP | | was | its IP |
| New | | address | Regular | discon- | address |
| device | P_device | changed | device | nected | changed |
| Devices | Devices | Devices | Devices | Devices | Devices |
| list | list | list | list | list | list |
| Updated | Updated | Updated | | Updated | |
| content | content | content | | content | |
| Update new | | Update new | | | Update new |
| IP address | | IP address | | | IP address |

In step 304, the device receives local or remote content. The content may be of any type. Optionally, the content may be categorized. In step 306 and optionally, the device performs one or more protective actions to form appropriate, non-defective and authorized content. Such actions may include for example a content policy check or preventing re-sharing of inappropriate and/or defective content. In step 308, the device distributes the appropriate, non-defective and authorized content formed in step 306 to all other devices connected over the P2P network. In step 310, the device displays the content to the user. Optionally, the user is protected from activating non-trusted content by the device requiring a password to display such content. Optionally yet, the protection may be done by the device requiring protection means other than a password, for example biometric means. Optionally, in step 312, the device allows a respective user to report the content type as being either inappropriate and/or defective (in which case this content may be deleted from all devices) or as being trusted content.

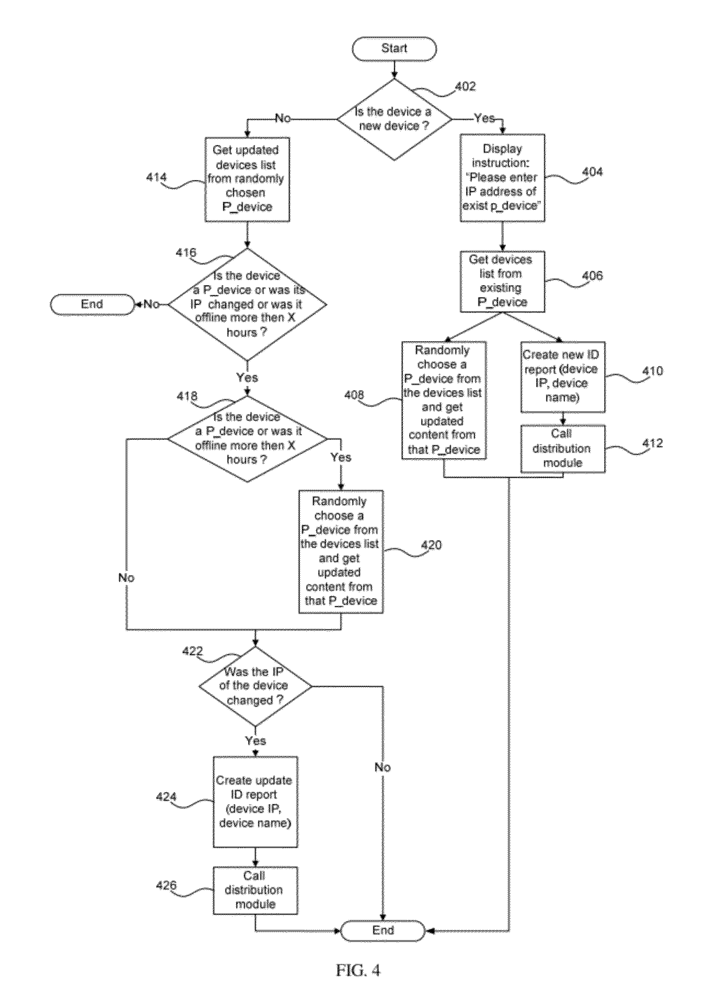

FIG. 4 is a flowchart illustrating steps performed by a network connection module in the system of FIG. 2b, in accordance with an embodiment disclosed herein. After a start in which a device connects to the network, in step 402, the network connection module checks whether a “new device flag” is ON. If YES (i.e. if the device is a new device and if this device connects to the network for the first time), the process continues to step 404, in which a user using the new device is requested to enter an IP address of an existing P_device into the device. In step 406, the network connection module receives a devices list from an existing P_device. In step 408, the module randomly chooses a P_device from the devices list and receives updated content from this P_device. In step 410, the module creates a new identification (ID) report, which may exemplarily include the IP address and name of the new device. In an embodiment, step 408 is performed in parallel with steps 410 and 412. The network connection module then calls the distribution module in step 412. The process ends after this call and after completion of the reception of updated content (following step 408).

If the check in step 402 indicates that the connection is not new (“new device flag” OFF), then in step 414 the network connection module receives an updated devices list from a randomly chosen P_device. In step 416, the network connection module checks whether the device is a P_device, whether the device IP was changed from the last time the device was connected to the network, or whether the device was offline for more than a predetermined time period. If NO in step 416, the process ends. If YES on either of these conditions, then the network connection module performs a further check in step 418 to determine if the device was offline for more than a predetermined time period or if it is a P_device. If YES in step 418 for either of these conditions, then in step 420 the network connection module chooses randomly a new P_device from the devices list, and the device receives updated content from the newly chosen P_device. If NO in step 418 or after step 420, the process continues to step 422, in which the network connection module checks whether the IP address of the device has been changed from the last time the device was connected to the network. If NO, the process ends. If YES in step 424, the module creates an updated ID report (to be distributed to all the other devices). This ID report may exemplarily include an IP address and a name of the device. Once an updated ID report is created, the network connection module calls the distribution module in step 426, after which the process ends.

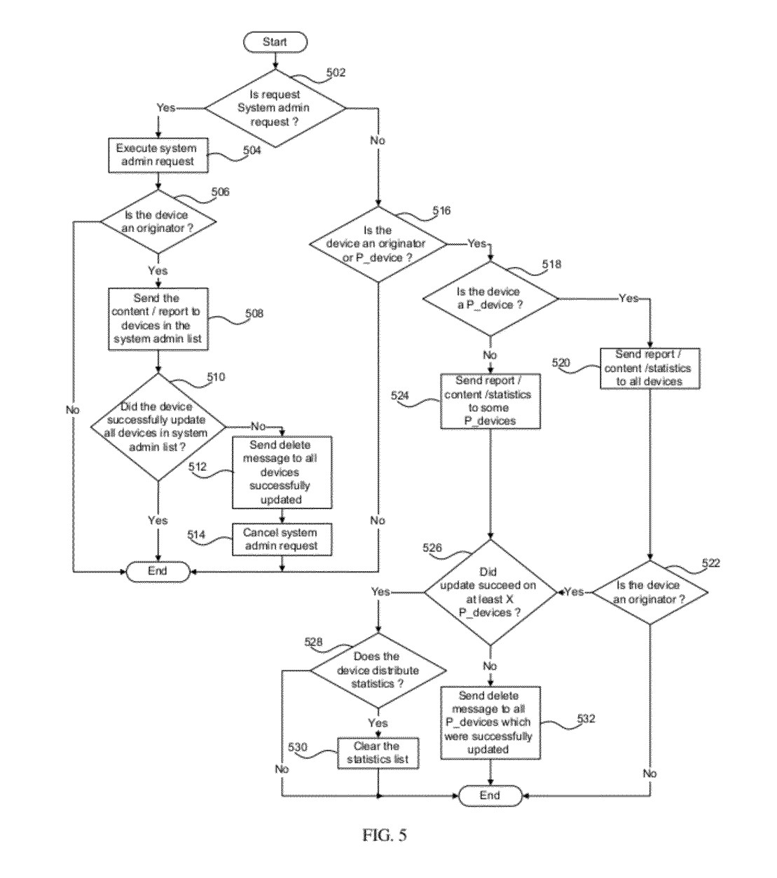

FIG. 5 is a flowchart illustrating steps performed by a distribution module in the system of FIG. 2b, in accordance with an embodiment disclosed herein. The process starts with an input such as content, a report (like the updated ID report in step 424 in FIG. 4) or a system administration update request. In step 502, the distribution module checks if the input is a system administration request (i.e. ID report). If YES, the module executes it in step 504. The module then checks if the device is an originator in step 506. If YES, the module sends the content and/or the message (administration update request) to all devices in the system administration list in step 508. The module then checks in step 510 if the device successfully updated all devices in the list. If YES, the process ends. If NO, then in step 512, the distribution module sends a “delete” message to all successfully updated P_devices, and in step 514 the distribution module cancels the system administration request, after which the process ends.

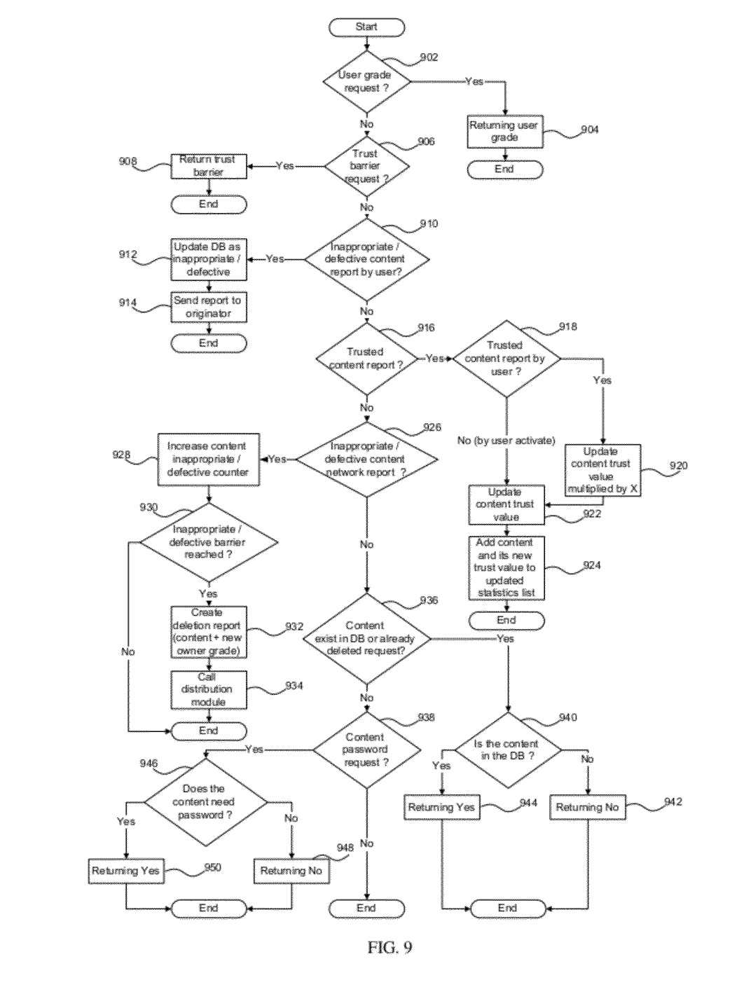

Returning to step 502, if the request is not a system administration request (i.e. content or ID report), the then in step 516 the distribution module checks if the respective device which received the input is an originator or a P_device. If NO to either, the process ends. If YES to either, the distribution module checks if the device is a P_device in step 518. If YES in step 518, then the distribution module sends the report or the content update to all devices in step 520 and further checks if the device is an originator in step 522. If NO in step 518, then the distribution module sends the input to some P_devices in step 524 and checks if the update was received successfully by at least X P_devices in step 526. The check in step 526 is also performed if the answer to the check in step 522 is YES. If NO in step 526, the distribution module sends a “delete” message to all successfully updated P_devices in step 532, after which the process ends. If YES in step 526, the module checks if the device distributes statistics in step 528 and if YES, clears a statistics list (see FIG. 9) in step 530, after which the process ends. If NO in step 528, the process ends.

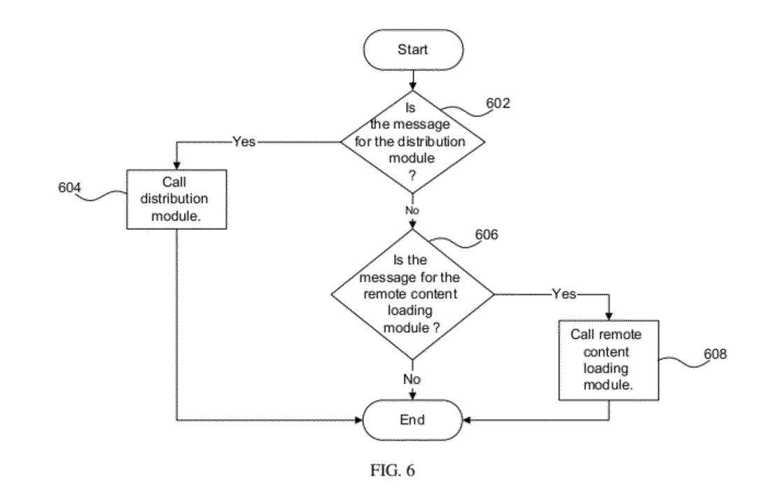

FIG. 6 is a flowchart illustrating steps performed by a message receive module in the system of FIG. 2b, in accordance with an embodiment disclosed herein. The process starts with an input as in the process of FIG. 5, wherein the input is received from other device. The message receive module of each device can also call the remote content loading module. In step 602, the message receive module checks if a received message is for the distribution module of its own device. If YES, the message receive module calls the distribution module, after which the process ends. If NO, the message receive module checks if the received message is for the remote content loading module of its own device in step 606. If YES, the message receive module calls the remote content loading module in step 608, after which the process ends.

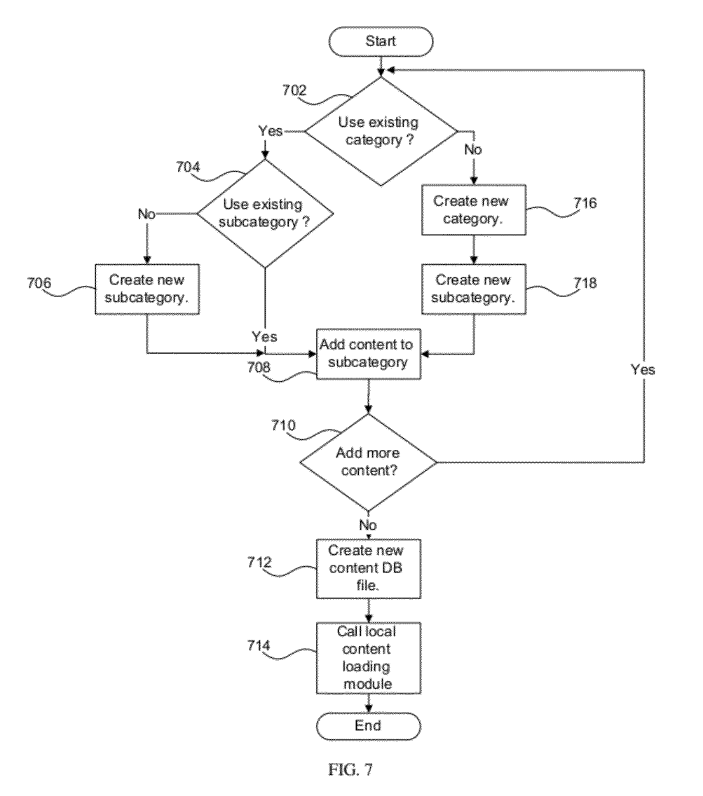

FIG. 7 is a flowchart illustrating steps performed by a content editing module in the system of FIG. 2b, in accordance with an embodiment disclosed herein. The process starts with content of an originator user. The user uploads the content to the device. This content may not be related to that of any other module. Note that the content editing module is “outside” the device in case the device is a set top box or another non-PC device. That is, the user can edit the content using a separate content editing application on his/her PC and not on the device and load the content later to a respective local device.

In step 702, a particular user is asked whether he/she wants to use a particular category to add some particular content to (i.e. to “categorize” some particular content). If NO, the module creates a new category in step 716, creates a new sub-category in step 718 and adds the particular content to the new sub-category in step 708. If YES in step 702, then in step 704 the particular user is asked whether he/she wants to use a particular sub-category to “subcategorize” the particular content categorized above. If NO in step 704, the module creates a new sub-category in step 706, and the process continues to step 708. If YES in step 704, the process advances directly to step 708. In step 710, the particular user is asked whether he/she wants to add more content to a category/sub-category. If YES, the process returns to step 702. If NO, then the module creates a “new content” database (“DB”) file in step 712, and then calls for the local content loading module in step 714, after which the process ends. The output here is categorized content.

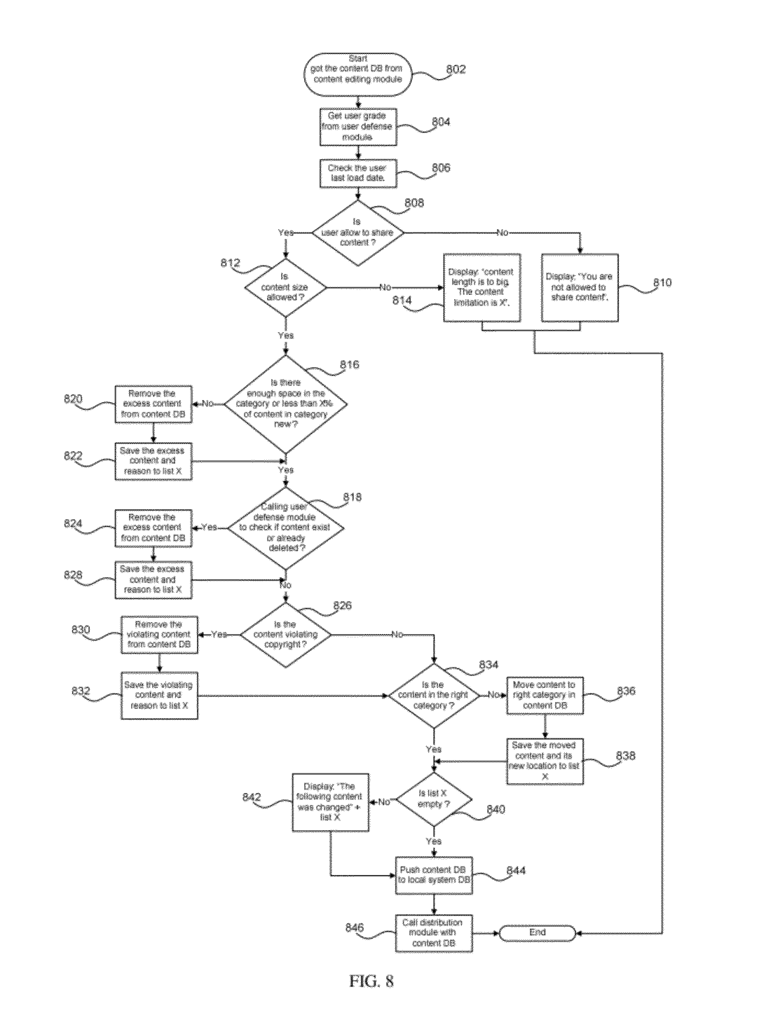

FIG. 8 is a flowchart illustrating steps performed by a local content loading module in the system of FIG. 2b, in accordance with an embodiment disclosed herein. In step 802, the local content loading module receives from the content editing module the “new content” DB file created in the process described with reference to FIG. 7. The local content loading module then receives a user grade from the user defense module in step 804, and checks the user's last loading date in step 806. All users have the privilege to load and share content every X number of days. The grade of a user who shared inappropriate and/or defective content will be lower than that of a user who did not share such content. Therefore, a user with lower grade can load and share content only every Y days (Y<X). Steps 804 and 806 check the user grade and the last time he/she shared content and provide an indication whether the user is allowed or not allowed to load and share content. The local content loading module then further checks in step 808 if the user is allowed to share content. If NO, the user is notified of this in step 810 and the process ends. If YES in step 808, then the local content loading module checks in step 812 if the content size is allowed (i.e. if it is below a predetermined size). If NO, the device displays a warning in step 814 (e.g. that the content size is too large), after which the process ends. If YES in step 812, then the local content loading module checks in step 816 if there is enough space in the category (obtained from the content editing module, to which the particular user decided to add content), or if less than a certain percentage of the content (e.g. 50%) in the category is new. If YES to either, then in step 818, the local content loading module calls the user defense module to check if the content in the DB exists or if it is already deleted. A YES answer means that either the content already exists in the DB or that the content was in the DB and has been already deleted. A NO answer means that neither has occurred. If NO in step 816, excess content is removed from the content DB in step 820, and saved to a list X maintained in a memory (not shown) together with the content DB in step 822, after which the process continues from step 818.

If the answer in step 818 is NO to either check, then the process continues to step 826 in which the content is checked to see if it violates copyright. If the answer in step 818 is YES to either check, the process continues to step 824 in which the excess content is removed from the content DB, and further to step 828, in which the excess content and reason are saved to list X after which the process continues from step 826. If the content checked in step 826 violates copyright, then this “violating” content is removed from the DB in step 830. The violating content and the reason for the deletion are then saved to a list X which includes content that was deleted from the DB in step 832, and the process continues to step 834. If the content checked in step 826 does not violate copyright, then in step 834 the content is checked to determine if it belongs in the correct category (e.g. if “adult” content belongs to the “adult” category). If it does, list X is checked to see if it is empty in step 840 and if it is empty, then the content DB is pushed to a local system DB (in the local device) in step 844. That is, a device receives the content DB and after all checking and changing saves the DB locally. The local content loading module then calls the distribution module with content DB in step 846, after which the process ends. If the content does not belong in the correct category in step 834, then the content is moved to the right category (step 836), the moved content and its location are saved to list X (step 838) and the process continues to step 840 as above.

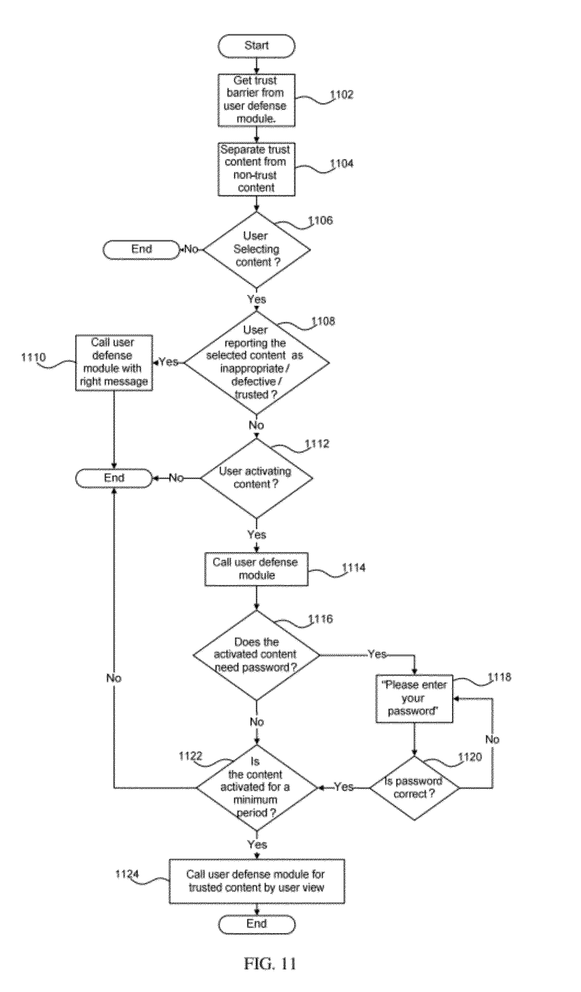

FIG. 9 is a flowchart illustrating steps performed by a user defense module in the system of FIG. 2b, in accordance with an embodiment disclosed herein. The process starts with inputs such as requests from other modules or user reports (e.g. user inappropriate content reports). Step 902 checks whether an input is a user grade request. If YES, the module returns a user grade to the local content loading module in step 904 after which the process ends. If NO, step 906 checks if the input is a trust barrier request (see FIG. 11). If YES, a trust barrier is returned to the user activating module (FIG. 11) in step 908, after which the process ends. If NO, step 910 checks if the input is a report from the user activating module reporting inappropriate or defective content. If YES, the DB is updated regarding such content is step 912, then a report is sent to the originator in step 914, after which the process ends. If NO in step 910, step 916 checks if the input is a trusted content report. If YES, step 918 checks if the trusted content report was sent by a user. If NO in step 918, the content is trusted because users activate it for more than a minimum period. In step 920, the trust value of content reported as trusted by a user (and not by activating the content by a user) is updated (increased by the number of time users report multiplied by 5). In step 922, the trust value of content which was activated for more than the minimum period is updated (increased by the number of time users activated this content). In step 924, the content and its new trust value are added to an updated statistics list (maintained in the memory) after which the process ends.

If NO in step 916, step 926 checks whether the input is a report of inappropriate/defective content received from the network If YES in step 926, a counter of inappropriate/defective content (maintained in the memory) is increased in step 928, and a check to see if a inappropriate/defective content barrier was reached is run in step 930. The barrier is a predefined number, for example 5-20% of the users. If NO in step 930, the process ends. If YES in step 930 (barrier was reached), then the user defense module creates a deletion report (which includes the content and a new owner grade, i.e. the grade of the user grade who shared this content) in step 932 and calls the distribution module in step 934, after which the process ends.

If NO in step 926, step 936 checks whether the input is a request for content already existing in the DB or already deleted. If YES in step 936 (i.e. either the content already exists in the DB or the content was in the DB and was deleted) the DB is searched for the existing content mentioned in the request in step 940. If the content is found, a confirmation is returned to the local content loading module in step 946, after which the process ends. If the content is not found a respective notification is returned to the local content loading module in step 944, after which the process ends.

If NO in step 936, step 938 checks whether the input is a password request. If NO, the process ends. If YES, step 948 checks whether the related content needs a password. Depending on the answer in step 948 (YES or NO), an appropriate confirmation (YES) or notification (NO) is returned to the user activating module, (see step 1116 in FIG. 11) in respectively steps 952 and 950, after which the process ends.

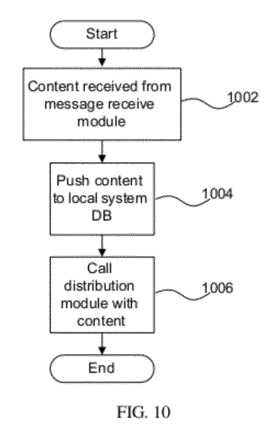

FIG. 10 is a flowchart illustrating steps performed by a remote content loading module in the system of FIG. 2b, in accordance with an embodiment disclosed herein. In general, an input here is a particular content DB from the network (i.e. from another device). The output might be redistributing this particular content DB to other devices. The process starts with content received from the message receive module in step 1002. The content is pushed to the local device DB in step 1004. The remote content loading module calls the distribution module and provides it with the content in step 1006, after which the process ends.

FIG. 11 is a flowchart illustrating steps performed by a user activating module in the system of FIG. 2b, in accordance with an embodiment disclosed herein. Inputs here may be parameters (e.g. a trust barrier) from the user defense module or user activities such as activating content or reporting content as inappropriate (see steps 1108, 1112). The process starts with the module receiving a trust barrier from the user defense module in step 1102. The user activating module then separates trusted content from non-trusted content according to their respective trust ratings as reflected in the trust barrier in step 1104. Step 1106 checks whether the user selects a particular content for activation. If NO, the process ends. If YES, step 1108 checks whether the selected content is reported by the user as inappropriate, defective or trusted content. If YES, the user activating module calls the user defense module with an appropriate message in step 1110, after which the process ends. If NO in step 1108, step 1112 checks whether the user activates the content. If NO, the process ends. If YES, the user activating module calls the user defense module in step 1114. The user defense module checks if the activated content needs a password in step 1116. If no password is needed, the content is activated (i.e. shown to the user) in step 1122 after which step 1124 checks if the content was activated for a minimum period (for example 5-30 minutes). If YES in step 1124, the user defense module is called in step 1126 for a content trust value update (see step 922) after which the process ends.

If in step 1116, the answer is YES (password needed), the user is prompted to enter his/her password in step 1118, and the entered password is checked in step 1120. If the password is correct, the process advances to step 1124. If not, the process returns to step 1118.

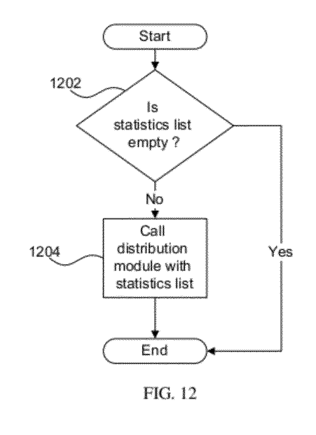

FIG. 12 is a flowchart illustrating steps performed by a statistics module in the system of FIG. 2b, in accordance with an embodiment disclosed herein. This module works periodically. This module checks if there is statistic report to send and if YES, it calls the distribution module to redistribute it to all other devices. In a typical process run by this module, step 1202 checks whether the statistics list is empty. If YES, the process ends. If NO, the statistics module calls the distribution module with the statistics list in step 1204, after which the process ends.

The various features and steps discussed above, as well as other known equivalents for each such feature or step, can be mixed and matched by one of ordinary skill in this art to perform methods in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein. For example, a device disclosed herein can be configured or otherwise programmed to implement the methods disclosed herein, and to the extent that a particular device disclosed herein is configured to implement the methods of this invention, it is within the scope and spirit of the present invention. Once a device disclosed herein is programmed to perform particular functions pursuant to computer-executable instructions from program software that implements the present invention, it in effect becomes a special purpose device particular to the present invention. The techniques necessary to achieve this are well known to those skilled in the art and thus are not further described herein.

Computer executable instructions implementing the methods and techniques of the present invention can be distributed to users on a computer-readable medium and are often copied onto a hard disk or other storage medium. When such a program of instructions is to be executed, it is usually loaded into the random access memory of the computer, thereby configuring the device to act in accordance with the techniques disclosed herein. All these operations are well known to those skilled in the art and thus are not further described herein. The term “device-readable medium” encompasses distribution media, intermediate storage media, execution memory of a device, and any other medium or device capable of storing for later reading by a device a program implementing the present invention.

Accordingly, drawings, tables, and description disclosed herein illustrate technologies related to the invention, show examples disclosed herein, and provide examples of using the invention and are not to be construed as limiting the present invention. Known methods, techniques, or systems may be discussed without giving details, so to avoid obscuring the principles disclosed herein. As it will be appreciated by one of ordinary skill in the art, the present invention can be implemented, modified, or otherwise altered without departing from the principles and spirit of the present invention. Therefore, the scope of the present invention should be determined by the following claims and their legal equivalents.

1. A method for content sharing in a peer-to-peer (P2P) network, comprising the steps of: by a device:
a) connecting to the P2P network; and
b) distributing identical content to all other devices connected to the P2P network.

2. The method of claim 1, wherein the content includes categorized content.

3. The method of claim 1, wherein the content includes trusted and non-trusted content, the method further comprising the step of:
c) protecting a user using the device from activating the non-trusted content.

4. The method of claim 1, wherein the content includes particular inappropriate or defective content, the method further comprising the steps of:
c) enabling users using respective devices to report the particular inappropriate or defective content; and
d) enabling the deletion of the particular inappropriate or defective content from all the devices connected to the P2P network.

5. The method of claim 2, wherein the categorized content includes categorized trusted and non-trusted content, the method further comprising the step of:
c) protecting a user using the device from activating the non-trusted content.

6. The method of claim 2, wherein the categorized content includes particular inappropriate or defective content, the method further comprising the steps of:
c) enabling users using respective devices to report the particular inappropriate or defective content; and
d) enabling the deletion of the particular inappropriate or defective content from all the devices connected to the P2P network.

7. The method of claim 5, wherein the non-trusted content includes particular inappropriate or defective content, the method further comprising the steps of:
d) enabling users using respective devices to report the particular inappropriate or defective content; and
e) enabling the deletion of the particular inappropriate or defective content from all the devices connected to the P2P network.

8. The method of claim 1, wherein the content includes trusted and non-trusted content, the method further comprising the steps of:
c) protecting a user using the device from activating the non-trusted content;
d) enabling users using respective devices to report particular inappropriate or defective content; and
e) enabling the deletion of the particular inappropriate or defective content from all the devices connected to the P2P network.

9. A method for content sharing in a peer-to-peer (P2P) network, comprising the steps of: by a device:
a) connecting to the P2P network; and
b) distributing categorized content to all other devices connected to the P2P network.

10. The method of claim 9, wherein the categorized content includes trusted and non-trusted categorized content, the method further comprising the step of:
c) protecting a user using the device from activating the non-trusted categorized content.

11. The method of claim 9, wherein the categorized content includes particular inappropriate or defective content, the method further comprising the steps of:
c) enabling users using respective devices to report the particular inappropriate or defective content; and
d) enabling the deletion of the particular inappropriate or defective content from all the devices connected to the P2P network.

12. The method of claim 11, wherein the categorized content includes trusted and non-trusted categorized content, the method further comprising the step of:
e) protecting a user using the device from activating the non-trusted categorized content.

13. A method for content sharing in a peer-to-peer (P2P) network, comprising the steps of: by a device:
a) connecting to the P2P network;
b) distributing content which includes trusted and non-trusted content to all other devices connected to the P2P network; and
c) protecting a user using the device from activating the non-trusted content.

14. The method of claim 13, wherein the non-trusted content includes particular inappropriate or defective categorized content, the method further comprising the steps of:
f) enabling users using respective devices to report particular inappropriate or defective categorized content; and
g) enabling the deletion of the particular inappropriate or defective categorized content from all the devices connected to the P2P network.

15. A method for content sharing in a peer-to-peer (P2P) network, comprising the steps of: by a device:
a) connecting to the P2P network;
b) enabling users using respective devices to report the particular inappropriate or defective content; and
c) enabling the deletion of the particular inappropriate or defective content from all the devices connected to the P2P network.

16. A computer readable medium carrying program instructions for performing a method for content sharing in a peer-to-peer (P2P) network, the method comprising the steps of: by a device:
a) connecting to the P2P network; and
b) distributing identical content to all other devices connected to the P2P network.

17. The computer readable medium of claim 16, wherein the content includes categorized content.

18. The computer readable medium claim 16, wherein the content includes trusted and non-trusted content, the method further comprising the step of:
c) protecting a user using the device from activating the non-trusted content.

19. The computer readable medium of claim 16, wherein the content includes particular inappropriate or defective content, the method further comprising the steps of:
c) enabling users using respective devices to report the particular inappropriate or defective content; and
d) enabling the deletion of the particular inappropriate or defective content from all the devices connected to the P2P network.

20. The computer readable medium of claim 17, wherein the categorized content includes categorized trusted and non-trusted content, the method further comprising the step of:
c) protecting a user using the device from activating the non-trusted content.

21. The computer readable medium of claim 17, wherein the categorized content includes particular inappropriate or defective content, the method further comprising the steps of:
c) enabling users using respective devices to report the particular inappropriate or defective content; and
d) enabling the deletion of the particular inappropriate or defective content from all the devices connected to the P2P network.

22. The computer readable medium of claim 20, wherein the non-trusted content includes particular inappropriate or defective content, the method further comprising the steps of:
d) enabling users using respective devices to report the particular inappropriate or defective content; and
e) enabling the deletion of the particular inappropriate or defective content from all the devices connected to the P2P network.

23. The computer readable medium of claim 16, wherein the content includes trusted and non-trusted content, the method further comprising the steps of:
c) protecting a user using the device from activating the non-trusted content;
d) enabling users using respective devices to report particular inappropriate or defective content; and
e) enabling the deletion of the particular inappropriate or defective content from all the devices connected to the P2P network.

24. A computer readable medium carrying program instructions for performing a method for content sharing in a peer-to-peer (P2P) network, comprising the steps of: by a device:
a) connecting to the P2P network; and
b) distributing categorized content to all other devices connected to the P2P network.

25. The computer readable medium of claim 24, wherein the categorized content includes trusted and non-trusted categorized content, the method further comprising the step of:
c) protecting a user using the device from activating the non-trusted categorized content.

26. The computer readable medium of claim 24, wherein the categorized content includes particular inappropriate or defective content, the method further comprising the steps of:
c) enabling users using respective devices to report the particular inappropriate or defective content; and
d) enabling the deletion of the particular inappropriate or defective content from all the devices connected to the P2P network.

27. The computer readable medium of claim 26, wherein the categorized content includes trusted and non-trusted categorized content, the method further comprising the step of:
e) protecting a user using the device from activating the non-trusted categorized content.

28. A computer readable medium carrying program instructions for performing a method for content sharing in a peer-to-peer (P2P) network, comprising the steps of: by a device:
a) connecting to the P2P network;
b) distributing content which includes trusted and non-trusted content to all other devices connected to the P2P network; and
c) protecting a user using the device from activating the non-trusted content.

29. The computer readable medium of claim 28, wherein the non-trusted content includes particular inappropriate or defective categorized content, the method further comprising the steps of:
d) enabling users using respective devices to report particular inappropriate or defective categorized content; and
e) enabling the deletion of the particular inappropriate or defective categorized content from all the devices connected to the P2P network.

30. A computer readable medium carrying program instructions for performing a method for content sharing in a peer-to-peer (P2P) network, comprising the steps of: by a device:
a) connecting to the P2P network;
b) enabling users using respective devices to report the particular inappropriate or defective content; and
c) enabling the deletion of the particular inappropriate or defective content from all the devices connected to the P2P network.
